(19) United States
(12) Patent Application Publication
(10) Pub. No.: US 2026/0279847 A1
(43) Pub. Date: Sep. 17, 2026

(54) FUEL CELL SEPARATOR AND METHOD FOR MANUFACTURING THE SAME

(71) Applicant: TOYOTA JIDOSHA KABUSHIKI KAISHA, Toyota-shi (JP)

(72) Inventor: Daichi MIYAZAKI, Toyota-shi (JP)

(73) Assignee: TOYOTA JIDOSHA KABUSHIKI KAISHA, Toyota-shi (JP)

(21) Appl. No.: 19/460,929

(22) Filed: Jan. 27, 2026

(30) Foreign Application Priority Data
Mar. 14, 2025 (JP) 2025-041946

(51) Int. Cl. H01M 8/0234; H01M 8/0232; H01M 8/0245; H01M 8/0254

(52) U.S. Cl. CPC H01M 8/0234; H01M 8/0232; H01M 8/0245; H01M 8/0254

(57) ABSTRACT

A fuel cell separator includes a metal substrate, and a carbon layer provided on the metal substrate. The carbon layer has a two-layer structure in which a granular layer and a columnar layer are stacked in the thickness direction of the carbon layer. The granular layer is a layer in which granular crystals are randomly deposited, and the columnar layer is a layer in which columnar crystals that each extend along the thickness direction of the carbon layer are aligned.

### CROSS-REFERENCE TO RELATED APPLICATION

This application claims priority to Japanese Patent Application No. 2025-041946 filed on March 14, 2025. The disclosure of the above-identified application, including the specification, drawings, and claims, is incorporated by reference herein in its entirety.

### BACKGROUND

### Technical Field

The present disclosure relates to separators for fuel cells and methods for manufacturing the same.

### Description of Related Art

As is known, a fuel cell includes, as a single cell, a structure in which an electrolyte membrane is sandwiched between an anode electrode and a cathode electrode. A fuel cell is formed as a stack in which a plurality of such single cells is stacked via separators (also referred to as bipolar plates) having grooves that serve as flow channels for gases such as hydrogen and oxygen. The output of the fuel cell can be increased by increasing the number of cells per stack.

A fuel cell separator also serves to conduct the current generated in one cell to an adjacent cell through the surface along which coolant flows. Therefore, the separator material is desired to be highly electrically conductive. Specifically, in a fuel cell separator, it is desirable to reduce the contact resistance between the separator and the adjacent electrode (in the case of a membrane electrode assembly (MEA)) or between the separator and the adjacent gas diffusion layer (in the case of a membrane electrode-gas diffusion layer assembly (MEGA)). Being highly electrically conductive means having low contact resistance.

To meet such demands, for example, Japanese Unexamined Patent Application Publication No. 2022-045138 (JP 2022-045138 A) discloses a fuel cell separator and a method for manufacturing the same. The fuel cell separator includes a metal substrate, an intermediate layer formed on the surface of the metal substrate, and a carbon layer formed on the surface of the intermediate layer.

### SUMMARY

However, the fuel cell separator disclosed in JP 2022-045138 A may, during power generation of the fuel cell, come into contact with product water of low pH (a corrosive liquid) that contains chloride ions or fluoride ions derived from the electrolyte membrane. In such cases, moisture from the product water can penetrate into the carbon layer, causing delamination of the carbon layer. As a result, the contact resistance of the fuel cell separator may increase.

The present disclosure has been made In view of the foregoing, and an object thereof is to provide a fuel cell separator and a method for manufacturing the same that can suppress moisture penetration into the carbon layer and reduce the possibility of delamination of the carbon layer.

In view of the above issue, a fuel cell separator according to the present disclosure includes a metal substrate, and a carbon layer provided on the metal substrate. The carbon layer has a two-layer structure in which a granular layer and a columnar layer are stacked in the thickness direction of the carbon layer. The granular layer is a layer in which granular crystals are randomly deposited, and the columnar layer is a layer in which columnar crystals that each extend along the thickness direction of the carbon layer are aligned.

The granular layer and the columnar layer may be provided in an order of the granular layer and the columnar layer from the metal substrate side toward a surface of the fuel cell separator. A surface of the metal substrate may be made of titanium or a titanium alloy. In that case, an intermediate layer made of titanium carbide may be provided between the metal substrate and the carbon layer.

A method for manufacturing a fuel cell separator according to the present disclosure is a method for manufacturing a fuel cell separator including a metal substrate and a carbon layer provided on the metal substrate. The method includes forming the carbon layer by physical vapor deposition. The forming of the carbon layer includes: forming a granular layer in which granular crystals are randomly deposited, either by applying a predetermined voltage as a bias voltage to the metal substrate or without applying the bias voltage to the metal substrate; and forming a columnar layer in which columnar crystals that each extend along a thickness direction of the carbon layer are aligned, by applying a bias voltage higher than the predetermined voltage to the metal substrate.

In the present disclosure, the carbon layer has a two-layer structure formed of a granular layer and a columnar layer, which can suppress water permeation near the interface between the granular layer and the columnar layer. It is therefore possible to suppress moisture penetration into the carbon layer and reduce the possibility of delamination of the carbon layer.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is an exploded perspective view of a single cell including fuel cell separators according to an embodiment of the present disclosure;

FIG. 1B is a cross-sectional view of a main part of a fuel cell in which the single cells shown in FIG. 1A are stacked;

FIG. 2A is a cross-sectional view of a main part of the fuel cell separator shown in FIG. 1A;

FIG. 2B is an enlarged cross-sectional view of a carbon layer in portion A shown in FIG. 2A;

FIG. 3 shows a transmission electron microscope (TEM) image of a portion including a carbon layer in a cross section of a test specimen of Example 1;

FIG. 4A is a spectral diagram obtained by measuring a portion including the carbon layer by electron energy loss spectroscopy (EELS);

FIG. 4B shows a mapping analysis image of the portion including the carbon layer, based on the bonding states of atoms obtained by the EELS measurement;

FIG. 5A is a graph showing the results of deuterium concentration along the depth direction of the test specimens of Example 1 and Comparative Examples 1 and 2;

FIG. 5B is a graph showing contact resistance values of the test specimens of Example 2 and Comparative Examples 3 and 4 as a function of constant potential test time; and

FIG. 6 is a table summarizing part of the test results shown in FIG. 5B together with images of the test specimens.

### DETAILED DESCRIPTION OF EMBODIMENTS

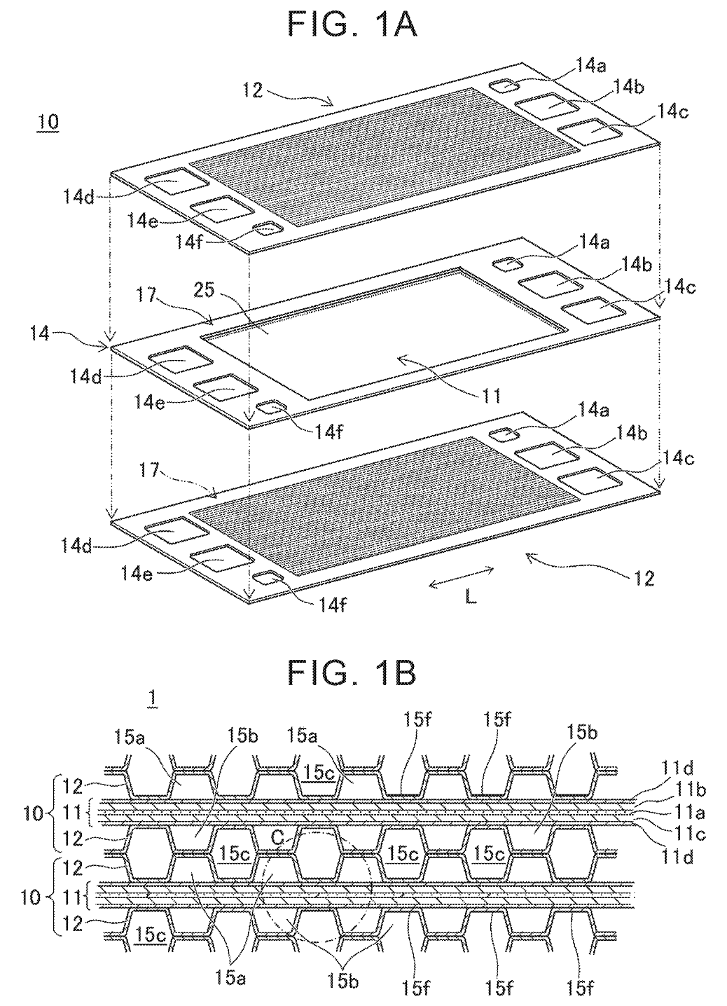

The fuel cell separator according to the present disclosure will be described below with reference to FIGS. 1A to 6. In the following description, the term "fuel cell separator" is simply referred to as "separator."

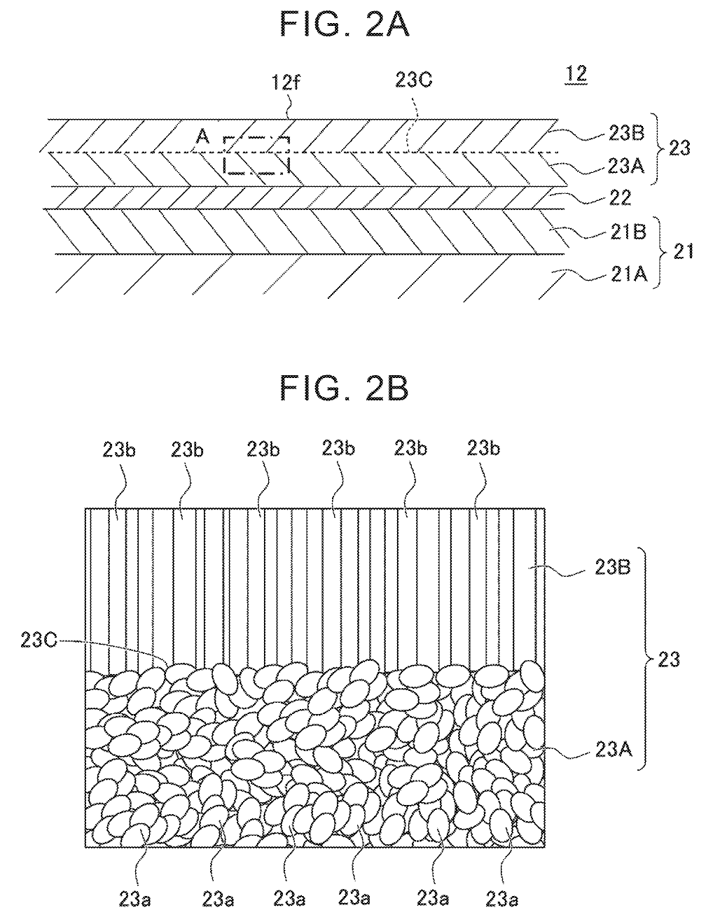

As shown in FIGS. 1A, 1B, 2A, and 2B, a fuel cell 1 according to an embodiment has a structure in which a plurality of single cells 10, serving as basic units, are stacked. The fuel cell 1 is a solid polymer fuel cell that generates electromotive force through an electrochemical reaction between an oxidant gas and a fuel gas. The oxidant gas is air. The air is compressed by, for example, a compressor. The air is supplied from the compressor to the fuel cell 1. The fuel gas is hydrogen gas. The hydrogen gas is stored in a high-pressure tank. The hydrogen gas is supplied from the high-pressure tank to the fuel cell 1.

As shown in FIG. 1A, each single cell 10 includes a power generation assembly 17 and a pair of separators 12 arranged to sandwich the power generation assembly 17. The power generation assembly 17 includes a membrane electrode-gas diffusion layer assembly (MEGA) 11 and a resin frame 14 surrounding the outer periphery of the MEGA 11.

As shown in FIG. 1B, the MEGA 11 includes an electrolyte membrane 11a and a pair of catalyst layers 11b, 11c. The catalyst layers 11b, 11c serve as the electrodes of the fuel cell. The catalyst layers 11b, 11c are bonded to the respective surfaces of the electrolyte membrane 11a. A gas diffusion layer 11d is bonded to the outer surface of the catalyst layer 11b, and another gas diffusion layer 11d is bonded to the outer surface of the catalyst layer 11c. The MEGA 11 is bonded to the resin frame 14 at a non-power-generation region.

The electrolyte membrane 11a is a proton-conductive ion-exchange membrane formed of a solid polymer material. The electrolyte membrane 11a may be, for example, a thin film of perfluorosulfonic acid polymer. The catalyst layers 11b, 11c are formed of a porous carbon material supporting a catalyst such as platinum. In the present embodiment, the catalyst layer 11b disposed on one side of the electrolyte membrane 11a serves as the anode catalyst layer of the single cell 10, and the catalyst layer 11c on the other side serves as the cathode catalyst layer of the single cell 10. Each gas diffusion layer 11d is formed of a gas-permeable, electrically conductive material such as a porous carbon material (e.g., carbon paper or carbon cloth) or a porous metal material (e.g., metal mesh or metal foam).

The resin frame 14 has a central opening and is shaped to surround a region including a power generation region 25 of the MEGA 11 and part of the non-power-generation region located around the power generation region 25. The resin frame 14 is fusion-bonded to the peripheral edge of one surface of the MEGA 11. The power generation region 25 of the MEGA 11 is sandwiched between the separators 12 and fusion-bonded to each of the separators 12. A hydrogen gas outlet 14a, a coolant inlet 14b, and an air inlet 14c are provided in this order on one side of each of the resin frame 14 and the separators 12. An air outlet 14d, a coolant outlet 14e, and a hydrogen gas inlet 14f are provided in this order on the other side of each of the resin frame 14 and the separators 12.

The separators 12 are members having a rectangular shape as viewed in plan and formed from a thin sheet or foil made of a metal such as stainless steel, titanium, or a titanium alloy. The thickness of each separator 12 is, for example, 10 μm to 200 μm. The thin sheet or foil used as the material of the separators 12 is produced by, for example, cold rolling. Each separator 12 is press-formed into a predetermined shape from this thin sheet or foil.

As shown in FIG. 1B, each separator 12 has a corrugated shape with an isosceles trapezoidal cross section. One surface of each separator 12 is in contact with the corresponding gas diffusion layer 11d of the MEGA 11 without adhesion. The other surface of each separator 12 is in contact with one surface of another adjacent separator 12. A plurality of ridges 15f is formed on the side of each separator 12 facing the MEGA 11. The ridges 15f extend in the longitudinal direction of the power generation region 25 of the MEGA 11. Gas flow channels 15a, 15b for hydrogen gas or air are thus formed between the ridges 15f. Coolant flow channels 15c are formed on the back side (opposite side) of the ridges 15f of each separator 12.

When hydrogen gas is supplied from the inlet 14f to the gas flow channels 15a and air is supplied from the inlet 14c to the gas flow channels 15b, an electrochemical reaction occurs within the single cell 10 to generate electromotive force. In this electrochemical reaction, protons (H⁺) and water produced at the anode-side catalyst layer 11b pass through the electrolyte membrane 11a in a hydrated state. As a result, water is produced at the cathode-side catalyst layer 11c. The product water is an acidic aqueous solution with a low pH. The product water may contain fluoride ions derived from the electrolyte membrane 11a. Such product water can damage the surface of the separator 12. Therefore, the following separator 12 is used in the present embodiment.

As shown in FIG. 2A, the separator 12 includes at least a metal substrate 21 and a carbon layer 23 formed on the metal substrate 21. In the present embodiment, an intermediate layer 22 made of titanium carbide is formed between the metal substrate 21 and the carbon layer 23.

The metal substrate 21 includes a stainless substrate 21A made of stainless steel, and a titanium layer 21B made of titanium or a titanium alloy. The type of stainless steel is not particularly limited. Examples include austenitic, ferritic, and austenitic–ferritic dual-phase stainless steels. The thickness of the metal substrate 21 is, for example, 0.05 mm to 1 mm.

The titanium layer 21B is a layer made of titanium or a titanium alloy. Providing the titanium layer 21B makes it possible to suppress corrosion of the stainless substrate 21A. Examples of titanium alloys include Ti–Al, Ti–Nb, Ti–Ta, Ti–6Al–4V, and Ti–Pd. The thickness of the titanium layer 21B is not particularly limited, and is, for example, 0.1 nm to 1000 nm, preferably 10 nm to 500 nm, and more preferably 30 nm to 300 nm. The metal substrate 21 may alternatively be made entirely of titanium or a titanium alloy.

The intermediate layer 22 is a layer made of titanium carbide. Providing the intermediate layer 22 ensures good adhesion between the titanium layer 21B and the carbon layer 23. The thickness of the intermediate layer 22 is, for example, 1 nm to 10 nm, and preferably 1 nm to 5 nm. The intermediate layer 22 may be omitted as long as sufficient adhesion between the metal substrate 21 and the carbon layer 23 can be ensured.

The carbon layer 23 has a two-layer structure in which a granular layer 23A and a columnar layer 23B are stacked in the thickness direction of the carbon layer 23. The granular layer 23A is a layer in which numerous granular crystals 23a are randomly deposited. The granular crystals 23a are carbon crystals having a particle size of about 0.1 nm to about 1.0 nm. The crystallinity of the granular crystals 23a is lower than that of columnar crystals 23b described below.

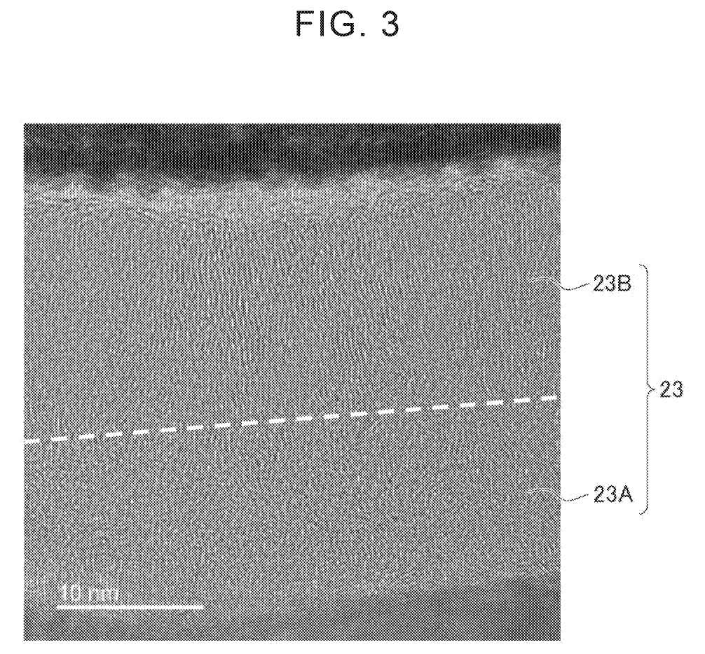

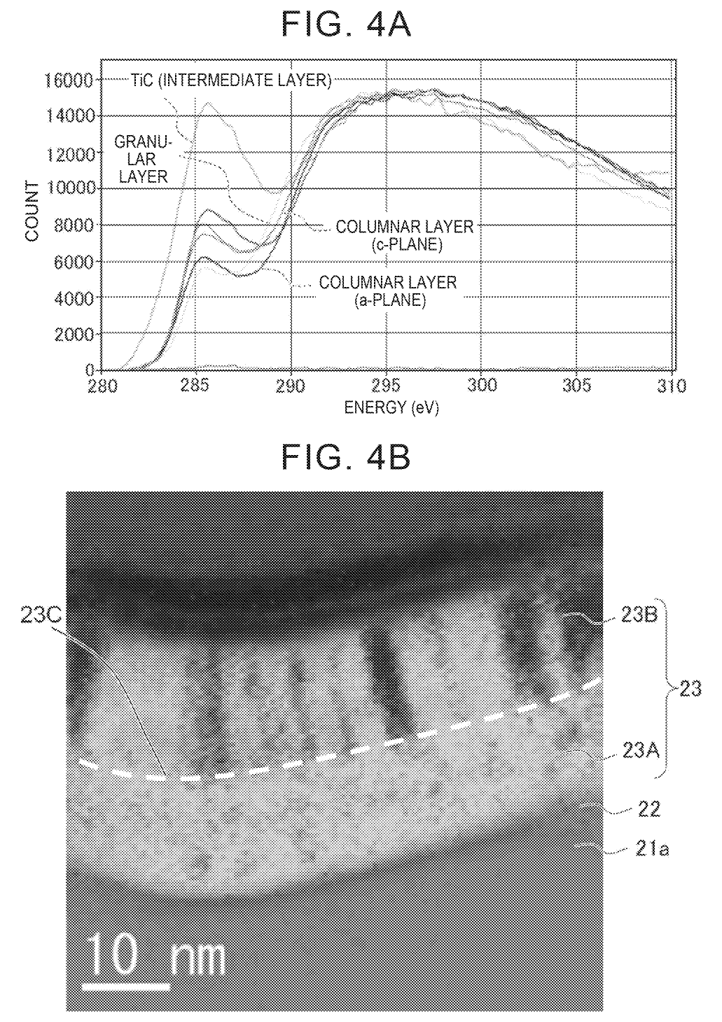

The columnar layer 23B is a layer in which columnar crystals 23b that each extend along the thickness direction of the carbon layer 23 are aligned. The columnar crystals 23b are carbon crystals and have an outer diameter of about 0.1 nm to about 1.0 nm. Each columnar crystal 23b is a carbon crystal in which carbon clusters are more densely aggregated than in the granular crystals 23a, and therefore has higher crystallinity. The shapes and crystallinities of the granular crystals 23a and the columnar crystals 23b can be confirmed from the transmission electron microscope (TEM) images of the carbon layer 23 (see FIG. 3), and from the spectrum and mapping analysis images of the carbon layer 23 obtained by electron energy loss spectroscopy (EELS) (see FIGS. 4A and 4B), as described later.

In the present embodiment, the granular layer 23A and the columnar layer 23B are stacked as two layers. An interface 23C is therefore formed between the granular layer 23A and the columnar layer 23B. By forming the interface 23C in the carbon layer 23, the regions on both sides of the interface 23C that differ in crystal shape and crystallinity function as portions of the carbon layer 23 having barrier properties against liquid penetration. As a result, penetration of water into the carbon layer 23 can be suppressed.

From this viewpoint, as long as the carbon layer 23 has a two-layer structure in which the granular layer 23A and the columnar layer 23B are stacked, the order in which the granular layer 23A and the columnar layer 23B are stacked with respect to the metal substrate 21 is not particularly limited. However, in a preferred embodiment, the granular layer 23A and the columnar layer 23B are formed in this order from the metal substrate 21 side toward a surface 12f of the separator 12. Specifically, the granular layer 23A is formed on the surface of the intermediate layer 22, and the columnar layer 23B is formed on the surface of the granular layer 23A. As described above, the columnar crystals 23b of the columnar layer 23B have higher crystallinity than the granular crystals 23a of the granular layer 23A. Placing the columnar layer 23B closer to the surface of the carbon layer 23 than the granular layer 23A can reduce the contact resistance of the separator 12.

The thickness of the carbon layer 23 is not particularly limited, and is preferably 10 nm to 500 nm, and more preferably 15 nm to 200 nm. As long as the interface 23C can be formed as described above, the thicknesses of the granular layer 23A and the columnar layer 23B are not particularly limited, and are preferably 5 nm to 100 nm. Similarly, as long as the interface 23C can be formed, the ratio of the thickness of the columnar layer 23B to that of the granular layer 23A is preferably in the range of 0.1 to 10.

The separator 12 can be manufactured as follows. First, a metal foil corresponding to the metal substrate 21 is prepared. Next, the metal foil is press-formed into the shape of the separator 12. Then, the intermediate layer 22 and the carbon layer 23 are formed on the surface of the metal substrate 21.

In the film-forming (deposition) process for the intermediate layer 22 and the carbon layer 23, the intermediate layer 22 and the carbon layer 23 are successively deposited by physical vapor deposition (PVD). As long as a carbon layer having the above-described different crystal structures can be formed by applying a bias voltage to the metal substrate 21, the specific physical vapor deposition (PVD) technique is not particularly limited. In the present embodiment, sputtering or ion plating may be employed as the PVD technique. By these methods, a carbon layer with a low hydrogen content can be formed. As a result, the proportion of carbon–carbon bonds (sp²-hybridized carbon) can be increased, and excellent electrically conductive properties can therefore be achieved.

Examples of sputtering techniques include magnetron sputtering, unbalanced magnetron sputtering (UBMS), dual magnetron sputtering, electron cyclotron resonance (ECR) sputtering, and high-power impulse magnetron sputtering (HiPIMS).

In forming the carbon layer 23, the granular layer 23A and the columnar layer 23B can be formed as follows. The granular layer 23A is formed by randomly depositing granular crystals 23a by applying a predetermined voltage as a bias voltage to the metal substrate 21. Alternatively, the granular layer 23A may be formed by randomly depositing granular crystals 23a without applying a bias voltage to the metal substrate 21.

As used herein, the "predetermined voltage" refers to the voltage applied between the carbon target and the metal substrate 21. The predetermined voltage is preferably less than 100 V. The expression "without applying a bias voltage to the metal substrate 21" means that no voltage is applied between the carbon target and the metal substrate 21. That is, the applied bias voltage is 0 V. By not applying a voltage to the metal substrate 21, granular crystals having significantly lower crystallinity than the columnar crystals 23b of the columnar layer 23B can be obtained. As a result, in the portion of the carbon layer 23 including the interface 23C, the barrier property of the carbon layer 23 against liquid penetration can be enhanced.

The columnar layer 23B is formed by applying to the metal substrate 21 a bias voltage higher than the predetermined voltage described above. The columnar layer 23B in which columnar crystals 23b that each extend along the thickness direction of the carbon layer 23 are aligned is thus formed. For example, the bias voltage applied here is preferably 100 V or higher and 300 V or lower. By applying a bias voltage within such a range to the metal substrate 21, columnar crystals 23b having higher crystallinity than the granular crystals 23a of the granular layer 23A can be obtained.

In the present embodiment, by setting the bias voltage in accordance with the voltage relationship described above, the granular layer 23A and the columnar layer 23B can be successively formed using the same film-forming apparatus. The order in which the granular layer 23A and the columnar layer 23B are formed is not particularly limited. However, in the present embodiment, it is preferable to form the columnar layer 23B on the surface of the granular layer 23A after forming the granular layer 23A. In this way, the columnar layer 23B can be formed closer to the surface of the carbon layer 23 than the granular layer 23A. As a result, the contact resistance of the separator 12 can be reduced.

The present embodiment will be described below using examples.

### Example 1

A test specimen corresponding to the metal substrate of the separator was fabricated. First, a stainless steel substrate (SUS304) with a thickness of 0.2 mm was prepared. Using a PVD film-forming apparatus (model FC1200, manufactured by Hauzer), titanium layers were formed on both surfaces of the stainless steel substrate. Specifically, after the stainless steel substrate was placed in the reaction chamber of the apparatus, the reaction chamber was evacuated and heated by an internal heater. A pure Ti cathode target used for sputtering was then etched (cleaned) with Ar plasma. To remove the passive film present on the surface of the stainless steel substrate, the stainless steel substrate was etched with Ar plasma. Thereafter, using the pure Ti cathode target described above, a titanium layer with a thickness of 220 nm was deposited by unbalanced magnetron sputtering (UBMS). Similarly, an intermediate layer made of titanium carbide and having a thickness of 2 nm was formed using a titanium carbide target.

Subsequently, using a high-purity tetrahedral amorphous carbon (ta-C) material as a carbon target, a carbon layer having a thickness of 30 nm was formed by arc ion plating (AIP). Specifically, a granular layer with a thickness of 15 nm was formed with the bias voltage to the metal substrate set to 0 V, that is, without applying a bias voltage to the metal substrate. The bias voltage was then changed to 150 V, and a columnar layer with a thickness of 15 nm was formed. A test specimen corresponding to the separator of Example 1 was fabricated in this manner.

### Comparative Example 1

A test specimen was fabricated in the same manner as in Example 1. Comparative Example 1 differs from Example 1 in that the bias voltage was set to 0 V and a carbon layer with a thickness of 35 nm was formed.

Comparative Example 2

A test specimen was fabricated in the same manner as in Example 1. Comparative Example 2 differs from Example 1 in that the bias voltage was set to 150 V and a carbon layer with a thickness of 35 nm was formed.

### Analysis of Carbon Layer

The portions including the carbon layers of the test specimens of Example 1 and Comparative Examples 1 and 2 were observed using a transmission electron microscope (TEM). A TEM image of Example 1 is shown in FIG. 3. Furthermore, the bonding states of atoms in the portion including the carbon layer of the test specimen of Example 1 were measured by electron energy loss spectroscopy (EELS). FIG. 4A is a spectral diagram obtained by measuring the portion including the carbon layer. FIG. 4B shows a mapping analysis image of the portion including the carbon layer, based on the bonding states of atoms obtained by the EELS measurement.

As shown in the TEM image in FIG. 3, Example 1 had the granular layer 23A in which granular crystals were randomly deposited, and the columnar layer 23B in which columnar crystals that each extend along the thickness direction of the carbon layer 23 were aligned. The carbon layer of Comparative Example 1 was formed of the granular layer alone. The carbon layer of Comparative Example 2 was formed of the columnar layer alone. As shown in FIGS. 4A and 4B, it was found that carbon crystals having different crystallinities were formed in the portion where the granular layer 23A and the columnar layer 23B were formed. From the intensities (counts) of the spectra at energies of 290eV and 295eV shown in FIG. 4A, it was found that the carbon clusters constituting the columnar crystals of the columnar layer 23B were aggregated. This indicates that the columnar crystals of the columnar layer 23B had higher crystallinity than the granular crystals of the granular layer 23A.

### Corrosion Resistance Test

A corrosion resistance test (constant potential corrosion test) was conducted on the test specimens of Example 1 and Comparative Examples 1 and 2 in accordance with the high-temperature electrochemical corrosion test method for metallic materials specified in Japanese Industrial Standard (JIS Z 2294). In an apparatus open to the atmosphere, an immersion solution was prepared by adding 3 ppm of fluorine ions to an aqueous sulfuric acid solution (300 mL, pH 3) with its temperature adjusted to 80°C by temperature-controlled water. Each test specimen was immersed in the immersion solution for eight hours. In this state, a platinum plate serving as the counter electrode and the test specimen (working electrode) were electrically connected to generate a potential difference of 0.9 V between the counter electrode and the working electrode, thereby causing corrosion of the test specimen. The potential of the test specimen was maintained constant by a reference electrode.

### Measurement of Deuterium Concentration

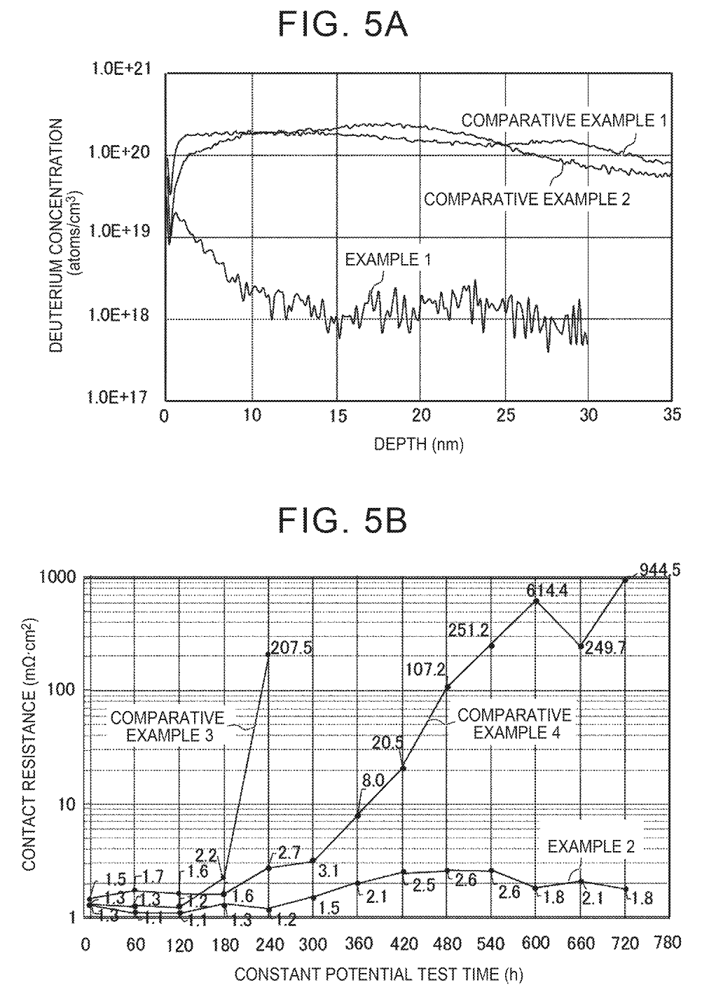

For the test specimens of Example 1 and Comparative Examples 1 and 2, the deuterium concentration in the thickness direction of the carbon layer was measured by secondary ion mass spectrometry (SIMS). The deuterium concentration corresponds to the amount of moisture that penetrated into the carbon layer during the corrosion resistance test. The results are shown in FIG. 5A. FIG. 5A is a graph showing the results of deuterium concentration along the depth direction of the test specimens of Example 1 and Comparative Examples 1 and 2.

From the results shown in FIG. 5A, the deuterium concentrations in the carbon layers of Comparative Examples 1 and 2 were about two orders of magnitude higher than that of Example 1. From these results, it was confirmed that moisture had penetrated into the carbon layer, regardless of whether the carbon layer was formed of the granular layer alone as in Comparative Example 1, or was formed of the columnar layer alone as in Comparative Example 2. On the other hand, in the case of Example 1, it is considered that, by forming the carbon layer with a two-layer structure of the granular layer and the columnar layer, penetration of water was suppressed in the region including the interface between the two layers.

### Example 2

A test specimen was fabricated in the same manner as in Example 1. Example 2 differs from Example 1 in that no intermediate layer was formed and the carbon layer was formed directly on the surface of the metal substrate. Example 2 also differs from Example 1 in that a carbon layer with a thickness of 35 nm was formed, with the granular layer and the columnar layer each having a thickness of 17.5 nm.

### Comparative Example 3

A test specimen was fabricated in the same manner as in Example 2. Comparative Example 3 differs from Example 2 in that the bias voltage was set to 250 V and a carbon layer (columnar layer) with a thickness of 100 nm was formed.

### Comparative Example 4

A test specimen was fabricated in the same manner as in Example 2. Comparative Example 4 differs from Example 2 in that the bias voltage was set to 150 V and a carbon layer (columnar layer) with a thickness of 35 nm was formed.

### Contact Resistance Measurement Test

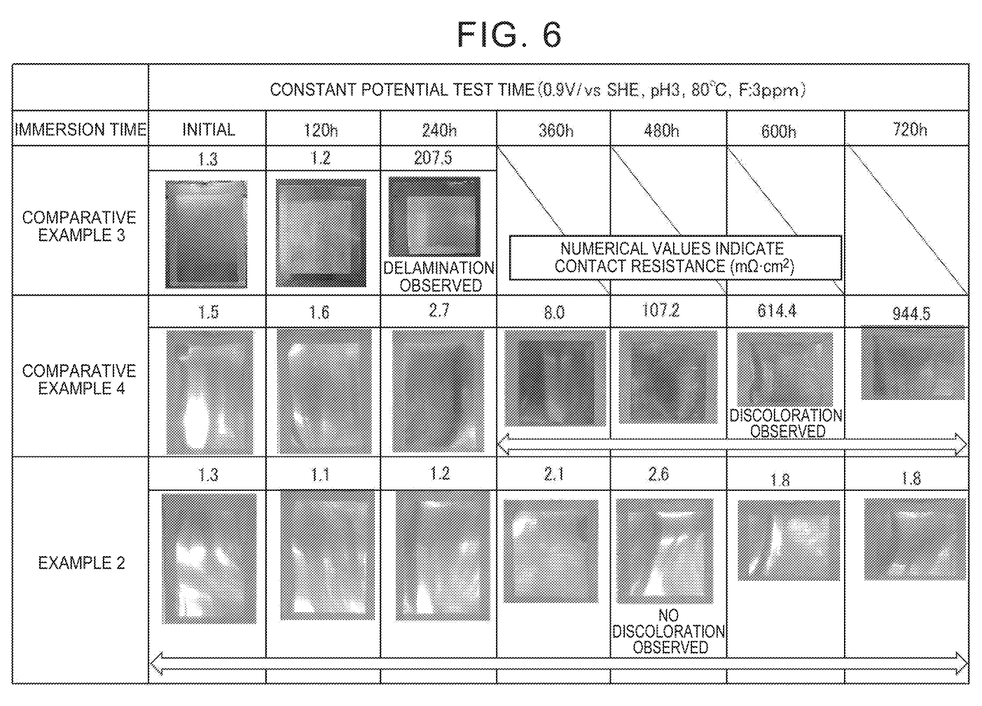

The initial contact resistance of the obtained separators was measured. For the contact resistance measurement, a carbon cloth was placed on one surface of a test specimen (separator), and the resulting stack was sandwiched between two copper electrodes and pressed under a load of 98 N (10kgf). In this state, a current was applied using a direct current power supply, the voltage applied between the carbon cloth and the substrate was measured with a voltmeter, and a contact resistance value was calculated. The results are shown in FIGS. 5B and 6. FIG. 5B is a graph showing the contact resistance values of the test specimens of Example 2 and Comparative Examples 3 and 4 as a function of constant potential test time. FIG. 6 is a table summarizing part of the test results shown in FIG. 5B together with images of the test specimens.

As shown in FIGS. 5B and 6, the contact resistance value of the test specimen of Example 2 hardly increased even as the test time increased, unlike the test specimens of Comparative Examples 3 and 4. In the case of Comparative Example 3, the contact resistance value increased as the test time progressed, and delamination of the carbon layer was observed when the test time reached 240 hours. The contact resistance value of the test specimen of Comparative Example 4 increased significantly as the test time increased, compared with the test specimen of Example 1. Furthermore, the test specimen of Comparative Example 4 turned brown after 360 hours of testing. As a result, the test specimen of Example 2, like that of Example 1, was able to suppress moisture penetration into the carbon layer. The test specimen of Example 2 was also able to suppress an increase in contact resistance.

While the embodiment of the present disclosure has been described in detail above, the present disclosure is not limited to the foregoing embodiment, and various design changes can be made without departing from the spirit of the disclosure as set forth in the claims.

What is claimed is:

1. A fuel cell separator comprising:
a metal substrate; and
a carbon layer provided on the metal substrate,
wherein the carbon layer has a two-layer structure in which a granular layer and a columnar layer are stacked in a thickness direction of the carbon layer, the granular layer being a layer in which granular crystals are randomly deposited, and the columnar layer being a layer in which columnar crystals that each extend along the thickness direction of the carbon layer are aligned.

2. The fuel cell separator according to claim 1, wherein the granular layer and the columnar layer are provided in an order of the granular layer and the columnar layer from the metal substrate side toward a surface of the fuel cell separator.

3. The fuel cell separator according to claim 1, wherein:
a surface of the metal substrate is made of titanium or a titanium alloy; and
an intermediate layer made of titanium carbide is provided between the metal substrate and the carbon layer.

4. A method for manufacturing a fuel cell separator including a metal substrate and a carbon layer provided on the metal substrate, the method comprising forming the carbon layer by physical vapor deposition,
wherein the forming of the carbon layer includes
forming a granular layer in which granular crystals are randomly deposited, either by applying a predetermined voltage as a bias voltage to the metal substrate or without applying the bias voltage to the metal substrate, and
forming a columnar layer in which columnar crystals that each extend along a thickness direction of the carbon layer are aligned, by applying a bias voltage higher than the predetermined voltage to the metal substrate.
